(19) United States
(12) Patent Application Publication
(10) Pub. No.: US 2003/0135418 A1
(43) Pub. Date: Jul. 17, 2003

(54) Point-of-sale (POS) systems that use a peripheral device for point-of-sale applications and methods of operating the same

(76) Inventors: Swetank Shekhar, Raleigh, NC (US); Barry Henderson, Rancho Santa Fe, CA (US); Ken Jenkins, Raleigh, NC (US)

Correspondence Address: MYERS BIGEL SIBLEY & SAJOVEC, PO BOX 37428, RALEIGH, NC, 27627, US

(21) Appl. No.: 10/232,027

(22) Filed: Aug. 30, 2002

Related U.S. Application Data
(60) Provisional application No. 60/347,710, filed on Jan. 11, 2002.
(60) Provisional application No. 60/354,707, filed on Feb. 6, 2002.

(51) Int. Cl. G06F 17/60

(52) U.S. Cl. 705/16

(57) ABSTRACT

A point-of-sale (POS) system includes a POS host terminal that includes a first POS management module that is configured to facilitate a POS transaction. A peripheral device, which may be for example, a smart card/debit card reader with an optional signature capture, is communicatively coupled to the POS host terminal and includes a second POS management module that is configured to facilitate the POS transaction with the POS host terminal being under the control of the peripheral device.

### RELATED APPLICATIONS

This application claims the benefit of Provisional Application No. 60/347,710, filed Jan. 11, 2002, and Provisional Application No. 60/354,707, filed Feb. 6, 2002, the disclosures of which are hereby incorporated herein by reference.

### BACKGROUND OF THE INVENTION

The present invention relates to data processing systems, and, more particularly, to point-of-sale (POS) systems and methods of operating the same.

Due to competition in the marketplace, retailers may demand more functionality from their POS terminals and/or registers that may enhance or enrich the customer shopping experience while meeting the requirements of customer satisfaction and loyalty programs. For example, as POS systems evolve, retailers may deploy new peripheral devices, such as devices that may enable signature capture and/or provide debit or smart card functionality, or include biometric support for security and/or customer identification. Retailers with legacy POS registers may be limited in the types of new functionality that may be provided, which may leave retailers with a decision of whether to forego adding new functionality, to remove some of the existing functionality to free up memory space for the new functionality, to consider costly hardware upgrades, or to migrate to new hardware. Some retailers may be faced with full POS register replacement, which may be cost prohibitive or detrimental to short-term capital expenditures.

Retailers may adopt a strategy of technology migration, but the new equipment may not be compatible with the legacy equipment; therefore, the POS architecture may be limited by the capabilities of the legacy equipment while the new equipment is being phased into the enterprise. The new equipment may run on a different operating system, support a different programming interface, require different register-to-server wiring, and/or require a different peripheral device interface. In some cases, the majority of the expense in a POS station is in the investment in various peripheral devices.

One migration strategy involves the installation of, for example, a processor motherboard in a peripheral device, such as a keyboard or printer. This motherboard may sometimes be referred to as a “brick” by those skilled in the art of retail POS system architecture design. The POS application from the POS legacy register may then be migrated to the motherboard and the POS legacy register may be discarded. Connectivity ports may be added to the motherboard or brick to facilitate communication with the other peripheral devices in the POS system. Unfortunately, such an architecture does not leverage the hardware and/or software available in the POS legacy register.

In view of the foregoing, there exists a need for improved POS systems that may preserve retailers' investments in legacy POS equipment while allowing migration to newer technologies.

### SUMMARY OF THE INVENTION

Point-of-sale (POS) system embodiments and methods of operating the same are provided that may preserve retailers' investments in legacy POS equipment while allowing migration to newer technologies. These POS system and method embodiments may allow a retailer to maintain both a single POS application code base and share peripheral devices across legacy and next generation equipment without having to upgrade and/or replace their existing POS terminal hardware. According to some embodiments of the present invention, a POS system comprises a POS host terminal that comprises a first POS management module that is configured to facilitate a POS transaction. A peripheral device, which may be for example, but is not limited to, a smart card/debit card reader with an optional signature capture, is communicatively coupled to the POS host terminal and comprises a second POS management module that is configured to facilitate the POS transaction with the POS host terminal being under the control of the peripheral device.

The POS host terminal may comprise a plurality of communication ports and may be operative as a communication hub. The peripheral device may be communicatively coupled to the POS host terminal via one of the plurality of communication ports. Thus, in accordance with some embodiments of the present invention, existing POS host terminal hardware may be preserved and used as a communication hub/driver for other devices.

In further embodiments of the present invention, the peripheral device may comprise a POS application module that is configured to facilitate an independent POS function, such as, but not limited to, reading electrical information carried on a card, reading magnetic information carried on a card, and electronically capturing a signature.

In still further embodiments of the present invention, a second peripheral device, which is under the control of the first peripheral device, may be communicatively coupled to the POS host terminal via a second one of the plurality of communication ports.

In other embodiments of the present invention, a server that has data stored thereon that is used in POS transactions is communicatively coupled to the peripheral device. In particular embodiments, the server is communicatively coupled to the peripheral device via the POS host terminal.

As discussed above, a peripheral device comprising a POS management module may be used to supplement legacy equipment, such as, for example, a POS host terminal. In still other embodiments, a peripheral device comprising a POS management module may be used to replace legacy equipment. For example, a POS system may comprise a communication hub that comprises a plurality of communication ports. A plurality of peripheral devices is coupled to the communication hub via the respective communication ports. One of the peripheral devices comprises both a POS management module that is configured to facilitate a POS transaction and a POS application module that is configured to facilitate an independent POS function.

Although described primarily above with respect to POS system embodiments of the present invention, it will be understood that the present invention may also be embodied as methods of retrofitting POS systems and/or methods of operating POS systems.

### BRIEF DESCRIPTION OF THE DRAWINGS

Other features of the present invention will be more readily understood from the following detailed description of specific embodiments thereof when read in conjunction with the accompanying drawings, in which:

FIGS. 1 and 2 are network schematics that illustrate point-of-sale (POS) systems in accordance with some embodiments of the present invention;

FIG. 3 is a block diagram that illustrates a software architecture for use in POS host terminals in accordance with some embodiments of the present invention;

FIG. 4 is a block diagram that illustrates a software architecture for use in a POS system peripheral device in accordance with some embodiments of the present invention;

FIG. 5 is a flowchart that illustrates operations for retrofitting a POS system in accordance with some embodiments of the present invention; and

FIGS. 6 and 7 are network schematics that illustrate POS systems in accordance with further embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. It will also be understood that when an element is referred to as being “connected” or “coupled” to another element, it can be directly connected or coupled to the other element or intervening elements may also be present. In contrast, when an element is referred to as being “directly connected” or “directly coupled” to another element, there are no intervening elements present.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

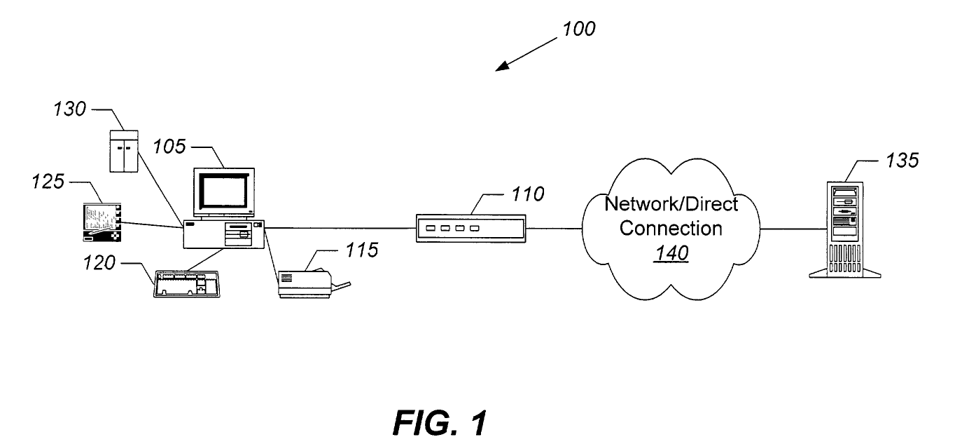

Referring now to FIG. 1, an exemplary point-of-sale (POS) system 100, in accordance with some embodiments of the present invention, comprises a POS host terminal or register 105, which may be a legacy POS terminal or POS cash register, and a plurality of peripheral devices 110, 115, 120, 125, 130, which are connected to the POS host terminal. These peripheral devices may comprise various types of devices, including, but not limited to, a printer, a keyboard, a display, a cash drawer, a data storage unit (e.g., a memory unit), a smart card/debit card reader, a signature capture unit, and/or a smart card/debit card reader with signature capture. It should be understood that, as used herein, “peripheral device” means any processing device that is connected to a POS host terminal or register via a communication medium and/or interface. Such devices may include, but are not limited to, embedded processor devices, workstations, personal computers, mobile communicators, personal digital assistants, pervasive communication devices, and the like. The communication medium and/or communication interface may be, for example, but is not limited to, a wireless medium, a wireline medium, a networked interface, such as a local and/or wide area network, a direct interface, such as a serial/parallel port interface and/or a PCMCIA interface, and a bus interface, such as a universal serial bus (USB) connection and/or peripheral component interconnect (PCI).

As will be described in more detail hereinafter, the POS host terminal 105 comprises a first POS management module that is configured to facilitate a POS transaction. In addition, the peripheral device 110, which may be embodied, for example, as a smart card/debit card reader, a signature capture unit, and/or a smart card/debit card reader with signature capture, comprises a second POS management module that is configured to facilitate a POS transaction where the POS host terminal 105 is under the control of the peripheral device 110. Thus, according to some embodiments of the present invention, the peripheral device 110 may effectively run the host terminal's POS register application thereon and, advantageously, may leverage the existing POS host terminal 105 hardware for use as a communication hub/driver for other peripheral devices. That is, the peripheral device 110 may control other peripheral devices in the POS system 100 to facilitate a POS transaction by using the POS host terminal 105 as a communication hub.

The POS system may further comprise a “backroom” server 135 that is communicatively coupled to the peripheral device 110 via a network/direct connection 140. As used herein, “communicatively coupled” may include, but is not limited to, wireless connections, wireline connections, networked connections, and/or combinations of the foregoing. The server 135 may contain data that are used in POS transactions, such as, for example, a pricing and/or inventory database. The network/direct connection 140 may be embodied, for example, as an integrated 10baseT/100baseT Ethernet connection, an integrated or expansion 802.11 wireless connection, and/or through existing wiring infrastructure.

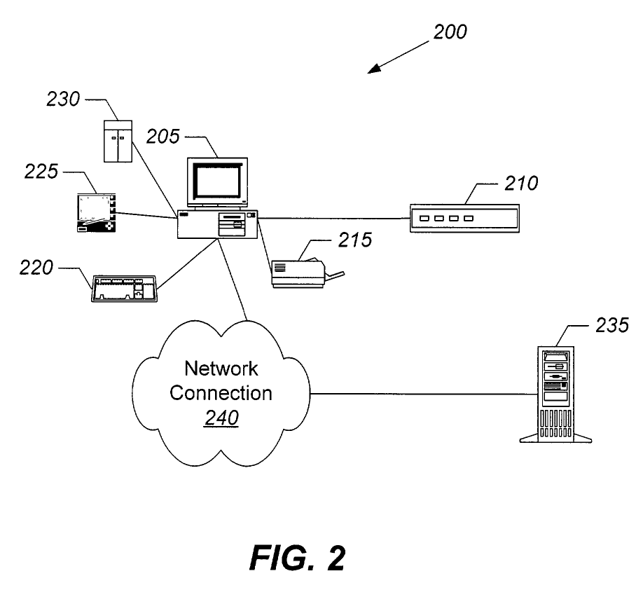

FIG. 2 illustrates an exemplary POS system 200, in accordance with other embodiments of the present invention. The POS system 200 comprises a host terminal 205, a plurality of peripheral devices 210, 215, 220, 225, and 230, a backroom server 235, and a network connection 240. These devices/units/interfaces are similar to those discussed above with reference to FIG. 1. In contrast to the POS system 100 of FIG. 1, however, the backroom server 235 is communicatively coupled to the peripheral device 210 via the POS host terminal 205 and the network connection 240.

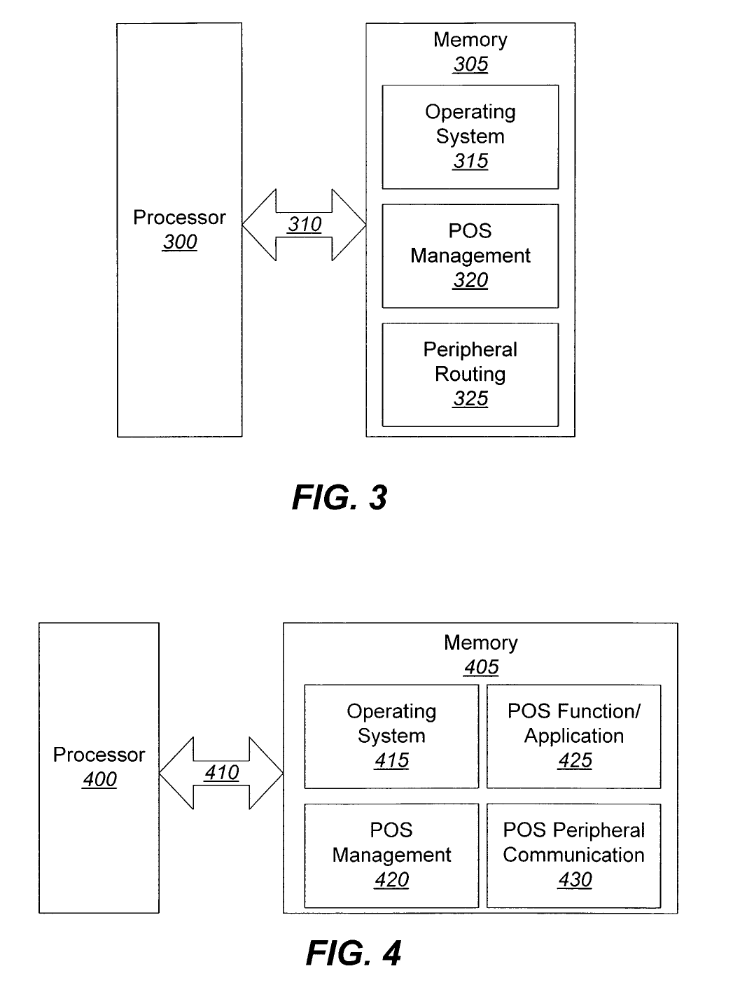

FIG. 3 illustrates a processor 300 and a memory 305 that may be used in embodiments of the POS host terminals 105 and 205 of FIGS. 1 and 2, respectively, in accordance with the present invention. The processor 300 communicates with the memory 305 via an address/data bus 310. The processor 300 may be, for example, a commercially available or custom microprocessor. The memory 305 is representative of the one or more memory devices containing the software and data used to facilitate a POS transaction in accordance with embodiments of the present invention. The memory 305 may include, but is not limited to, the following types of devices: cache, ROM, PROM, EPROM, EEPROM, flash, SRAM, and DRAM.

As shown in FIG. 3, the memory 305 may contain up to three or more categories of software and/or data: an operating system 315, a POS management module 320, and a peripheral routing module 325. The operating system 315 generally controls the operation of the host terminal. In particular, the operating system 315 may manage the POS host terminal's software and/or hardware resources and may coordinate execution of programs by the processor 300. The POS management module 320 may be configured to control peripheral device(s) that are connected to the POS host terminal to facilitate POS transaction(s). The POS management module 320 may be, for example, a legacy POS register application. The peripheral routing module 325 may be configured to facilitate communication with the peripheral device(s) that are communicatively coupled to the POS host terminal.

Although FIG. 3 illustrates an exemplary POS host terminal software architecture in accordance with some embodiments of the present invention, it will be understood that the present invention is not limited to such a configuration but is intended to encompass any configuration capable of carrying out operations described herein.

FIG. 4 illustrates a processor 400 and a memory 405 that may be used in embodiments of the peripheral devices 110 and 210 of FIGS. 1 and 2, respectively, in accordance with the present invention. The processor 400 communicates with the memory 405 via an address/data bus 410. The processor 400 may be, for example, a commercially available or custom microprocessor. The memory 405 is representative of the one or more memory devices containing the software and data used to facilitate a POS transaction in accordance with embodiments of the present invention. The memory 405 may include, but is not limited to, the following types of devices: cache, ROM, PROM, EPROM, EEPROM, flash, SRAM, and DRAM.

As shown in FIG. 4, the memory 405 may contain up to four or more categories of software and/or data: an operating system 415, a POS management module 420, a POS function/application 425, and a POS peripheral communication module 430. The operating system 415 generally controls the operation of the peripheral device. In particular, the operating system 415 may manage the peripheral device's software and/or hardware resources and may coordinate execution of programs by the processor 400. The POS management module 420 may be configured to control peripheral device(s) that are communicatively coupled to the POS host terminal (e.g., POS host terminals 105 and 205) to facilitate POS transaction(s). For example, in some embodiments, the POS management module 420 may effectively implement a POS register application that traditionally runs on a legacy host terminal/register. The POS function/application module 425 may be configured to facilitate one or more independent POS functions that are associated with the peripheral device. Such function(s)/application(s) may include, but is not limited to, reading electrical information carried on a card, reading magnetic information carried on a card, and/or electronically capturing a signature. The POS peripheral communication module 430 may be configured to facilitate communication with peripheral devices that are connected to the POS host terminal by communicating, for example, with the peripheral routing module 325 of FIG. 3, and may also be configured to facilitate communication with a server (e.g., servers 135 and 235) through the POS host terminal or without going through the POS host terminal.

Although FIG. 4 illustrates an exemplary peripheral device software architecture in accordance with some embodiments of the present invention, it will be understood that the present invention is not limited to such a configuration but is intended to encompass any configuration capable of carrying out operations described herein.

Computer program code for carrying out operations of the respective POS host terminal and peripheral device program modules discussed above with respect to FIGS. 3 and 4 may be written in a high-level programming language, such as C or Visual Basic, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

In particular embodiments of the present invention, the peripheral device POS management module 420 of FIG. 4 may be written in an object oriented programming language, such as C++, or Java, which has been developed by Sun Microsystems, Mountain View, Calif. Java is a portable and architecturally neutral language. Java source code is compiled into a machine independent format that may be run on machines configured with a Java runtime system known as a Java Virtual Machine (JVM). The JVM is defined as an imaginary machine that is implemented by emulating a processor through the use of software on a real machine. Accordingly, machines running under diverse operating systems, including UNIX and Windows NT, having a JVM can execute the same Java program. Thus, the operating system 415 may comprise a JVM in accordance with some embodiments of the present invention.

The present invention is described hereinafter with reference to flowchart and/or block diagram illustrations of methods, systems, and computer program products in accordance with exemplary embodiments of the invention. These flowchart and/or block diagrams further illustrate exemplary operations of retrofitting a POS system in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

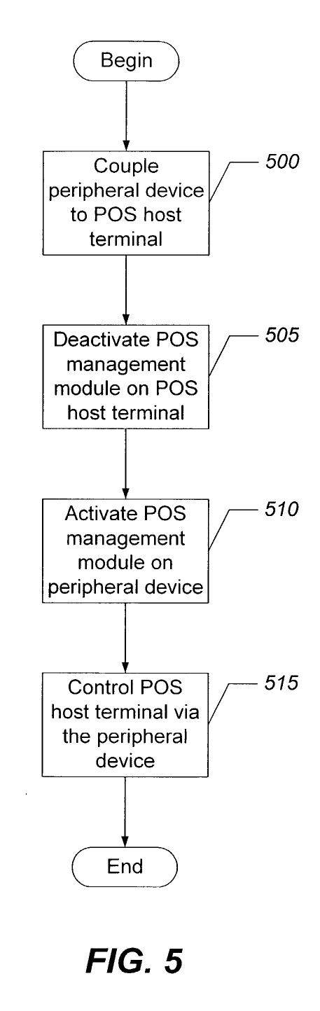

Referring now to FIG. 5, exemplary operations for retrofitting a POS system begin at block 500 where a peripheral device, such as peripheral devices 110 and 210 of FIGS. 1 and 2, respectively, is communicatively coupled to a POS host terminal, such as POS host terminals 105 and 205 of FIGS. 1 and 2, respectively. The POS management module 320 of FIG. 3 is deactivated on the POS host terminal at block 505. The POS management module 420 on the peripheral device is activated at block 510. The POS system is now under the control and supervision of the POS management module 420 running on the peripheral device. Thus, at block 515, the POS host terminal may be controlled via the peripheral device to facilitate a POS transaction in accordance with some embodiments of the present invention.

In further embodiments, one or more additional peripheral devices may be coupled to the POS host terminal as shown in FIGS. 1 and 2 and the POS management module 420 running on the first peripheral device (i.e., peripheral device 110 or 210) may be used to control these additional peripheral device(s) using the POS host terminal as a communication hub via the peripheral routing module 325 and the POS peripheral communication module 430.

The flowchart of FIG. 5 illustrates the architecture, functionality, and operations of embodiments of the POS systems 100 and 200 software. In this regard, each block represents a module, segment, or portion of code, which comprises one or more executable instructions for implementing the specified logical function(s). It should also be noted that in other implementations, the function(s) noted in the blocks may occur out of the order noted in FIG. 5. For example, two blocks shown in succession may, in fact, be executed substantially concurrently or the blocks may sometimes be executed in the reverse order, depending on the functionality involved.

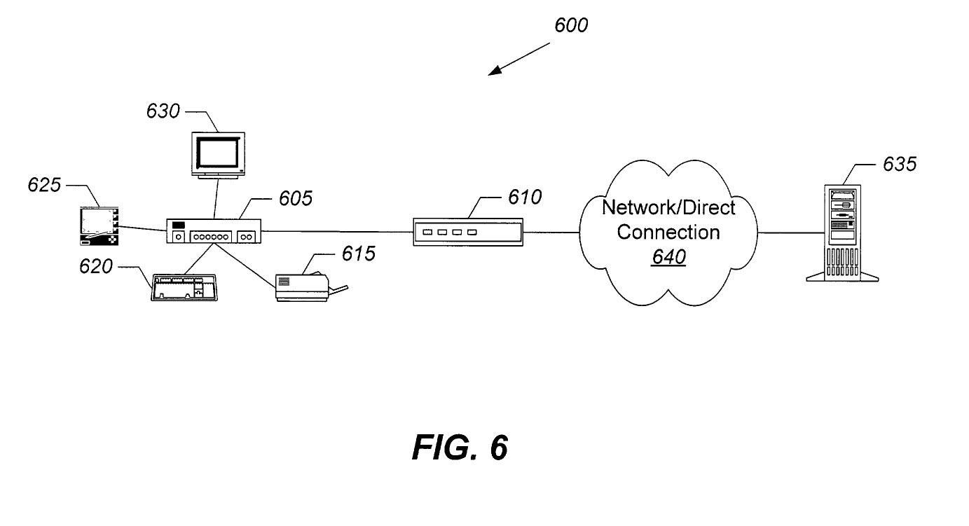

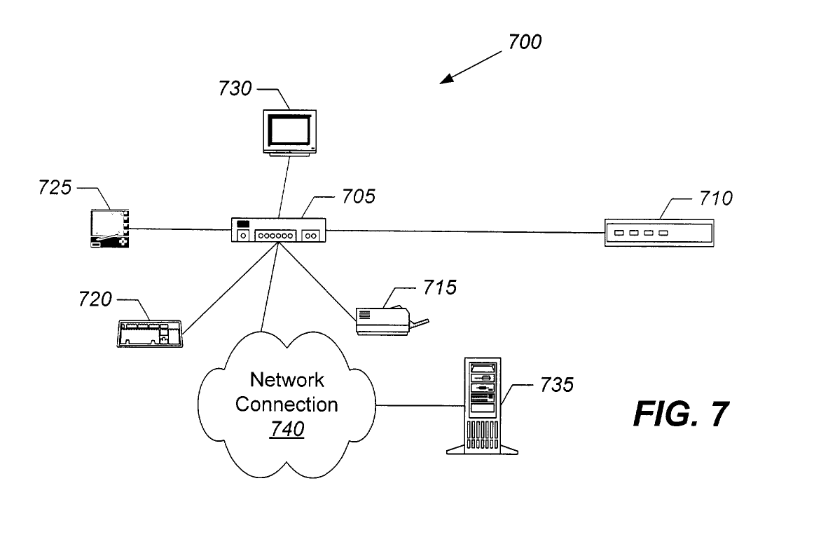

As discussed above, a peripheral device having a POS management module 420 running thereon, such as peripheral devices 110 and 210 of FIGS. 1 and 2, may supplement legacy equipment, such as, for example, POS host terminals 105 and 205 of FIGS. 1 and 2. In still other embodiments, peripheral devices having a POS management module 420 running thereon may be used to replace legacy equipment as illustrated in FIGS. 6 and 7.

Referring now to FIG. 6, an exemplary POS system 600 in accordance with some embodiments of the present invention comprises a communication hub 605, a plurality of peripheral devices 610, 615, 620, 625, and 630, a backroom server 635, and a network/direct connection 640. With the exception of the communication hub 605, these devices/units/interfaces are similar to those discussed above with reference to FIG. 1. In contrast to the POS system 100 of FIG. 1, however, the POS host terminal 105 is replaced with a communication hub 605. Thus, the peripheral devices 615, 620, 625, and 630 may comprise functionally equivalent devices that otherwise would typically be provided by a POS host terminal. Because the communication hub 605 has replaced the POS host terminal, the peripheral routing functionality provided by the POS host terminal's peripheral routing module 325 of FIG. 3 may be replaced by incorporating such functionality in the POS peripheral communication module 430, which may run on the peripheral device 610. In contrast with conventional POS legacy host terminal replacement architectures discussed above, in which a “brick” is used to retrofit a peripheral device to run a POS application and to facilitate communication among peripheral devices, a separate communication hub 605 is used to interconnect the peripheral devices rather than incorporating connectivity ports on the peripheral device retrofitted with the “brick” or motherboard.

FIG. 7 illustrates an exemplary POS system 700, in accordance with other embodiments of the present invention. The POS system 700 comprises a communication hub 705, a plurality of peripheral devices 710, 715, 720, 725, and 730, a backroom server 735, and a network connection 740. These devices/units/interfaces are similar to those discussed above with reference to FIG. 6. In contrast to the POS system 600 of FIG. 6, however, the backroom server 735 is communicatively coupled to the peripheral device 710 via the communication hub 705 and the network connection 740.

Whether following an explicit migration plan, replacing failing legacy registers with new technology, or using next generation registers in new stores, retailers typically need to ensure that legacy and new equipment are compatible in both intra-store and inter-store environments. As discussed above, embodiments of the present invention may allow retailers to use the same POS application regardless of whether the retailers choose to maintain their legacy POS terminals/registers or replace their legacy POS terminals/registers with next generation registers. Advantageously, only a single PO application need be maintained. This remains true regardless of the new hardware decision. Other environments, such as PDA devices and/or handheld devices, may be supported in a thin client configuration using, for example, the Enterprise Retail Server (ERS) platform provided by Integrated Software Solutions, Raleigh, N.C. By adding a peripheral expansion hub to a peripheral device running a POS management module, which supports a legacy host terminal, new technology peripherals not otherwise supported by the legacy hardware may be added to the POS system. Those same peripherals may be attached to, and shared with, next generation hardware, which may simplify support and maintenance requirements.

Many variations and modifications can be made to the preferred embodiments without substantially departing from the principles of the present invention. All such variations and modifications are intended to be included herein within the scope of the present invention, as set forth in the following claims.

We claim:

1. A point-of-sale (POS) system, comprising:
a POS host terminal that comprises a first POS management module that is configured to facilitate a POS transaction; and
a peripheral device that is communicatively coupled to the POS host terminal and comprises a second POS management module that is configured to facilitate the POS transaction, the POS host terminal being under the control of the peripheral device.

2. The POS system of claim 1, wherein the POS host terminal comprises a plurality of communication ports and is operative as a communication hub, the peripheral device being communicatively coupled to the POS host terminal via a first one of the plurality of communication ports.

3. The POS system of claim 2, wherein the peripheral device is a first peripheral device, the POS system further comprising:
a second peripheral device communicatively coupled to the POS host terminal via a second one of the plurality of communication ports, the second peripheral device being under the control of the first peripheral device.

4. The POS system of claim 1, wherein the peripheral device further comprises a POS application module that is configured to facilitate an independent POS function.

5. The POS system of claim 4, wherein the independent POS function comprises at least one function selected from the group of functions consisting of reading electrical information carried on a card, reading magnetic information carried on a card, and electronically capturing a signature.

6. The POS system of claim 1, wherein the POS host terminal is a POS cash register.

7. The POS system of claim 1, wherein the peripheral device comprises at least one device selected from the group of devices consisting of a smart card reader, a debit card reader, and a signature capture device.

8. The POS system of claim 1, wherein the peripheral device comprises an embedded processor device.

9. The POS system of claim 1, wherein the peripheral device comprises a personal computer.

10. The POS system of claim 1, wherein the peripheral device comprises a workstation.

11. The POS system of claim 1, wherein the peripheral device comprises a personal digital assistant.

12. The POS system of claim 1, further comprising a server that is communicatively coupled to the peripheral device and having data stored thereon that are used in POS transactions.

13. The POS system of claim 12, wherein the server is communicatively coupled to the peripheral device via the POS host terminal.

14. A point-of-sale (POS) system, comprising:
a communication hub that comprises a plurality of communication ports; and
a plurality of peripheral devices coupled to the communication hub via the respective communication ports, one of the plurality of peripheral devices comprising a POS management module that is configured to facilitate a POS transaction and a POS application module that is configured to facilitate an independent POS function.

15. The POS system of claim 14, wherein at least one other one of the plurality of peripheral devices is under the control of the one of the plurality of peripheral devices.

16. The POS system of claim 14, wherein the independent POS function comprises at least one function selected from the group of functions consisting of reading electrical information carried on a card, reading magnetic information carried on a card, and electronically capturing a signature.

17. The POS system of claim 14, wherein the one of the plurality of peripheral devices comprises at least one device selected from the group of devices consisting of a smart card reader, a debit card reader, and a signature capture device.

18. The POS system of claim 14, further comprising a server that is communicatively coupled to the one of the plurality of peripheral devices and having data stored thereon that are used in POS transactions.

19. The POS system of claim 18, wherein the server is communicatively coupled to the peripheral device via the communication hub.

20. A method of retrofitting a point-of-sale (POS) system, comprising:
providing a POS host terminal that comprises a first POS management module that is configured to facilitate a POS transaction;
communicatively coupling a peripheral device to the POS host terminal, the peripheral device comprising a second POS management module that is configured to facilitate the POS transaction;
deactivating the first POS management module; and
activating the second POS management module.

21. The method of claim 20, further comprising:
controlling the POS host terminal via the peripheral device.

22. The method of claim 21, wherein the peripheral device is a first peripheral device, the method further comprising:
communicatively coupling a second peripheral device to the POS host terminal; and
controlling the second peripheral device via the first peripheral device.

23. The method of claim 20, further comprising:
communicatively coupling a server having data stored thereon that are used in POS transactions to the peripheral device.

24. The method of claim 23, wherein communicatively coupling the server comprises:
communicatively coupling the server to the POS host terminal.

25. The method of claim 20, wherein the POS host terminal is a POS cash register.

26. The method of claim 20, wherein the peripheral device comprises at least one device selected from the group of devices consisting of a smart card reader, a debit card reader, and a signature capture device.

27. The method of claim 20, wherein the peripheral device comprises an embedded processor device.

28. The method of claim 20, wherein the peripheral device comprises a personal computer.

29. The method of claim 20, wherein the peripheral device comprises a workstation.

30. The method of claim 20, wherein the peripheral device comprises a personal digital assistant.

31. A method of operating a point-of-sale (POS) system, comprising:
providing a POS host terminal that comprises a first POS management module that is configured to facilitate a POS transaction;
providing a peripheral device that is communicatively coupled to the POS host terminal, the peripheral device comprising a second POS management module that is configured to facilitate the POS transaction; and
operating the POS host terminal and the peripheral device under the control of the second POS management module of the peripheral device to perform the POS transaction.

32. The method of claim 31, wherein the peripheral device is a first peripheral device, the method further comprising:
providing a second peripheral device that is communicatively coupled to the POS host terminal; and wherein operating the POS host terminal and the peripheral device comprises:
operating the POS host terminal, the first peripheral device, and the second peripheral device under the control of the second POS management module of the first peripheral device to perform the POS transaction.

33. The method of claim 31, further comprising:
providing a server that is communicatively coupled to the peripheral device and has data stored thereon that are used in POS transactions; and
communicating with the server to obtain information at the peripheral device that is used in operating the POS host terminal and the peripheral device.

34. The method of claim 33, wherein the server is communicatively coupled to the peripheral device via the POS host terminal.

35. The method of claim 31, wherein the POS host terminal is a POS cash register.

36. The method of claim 31, wherein the peripheral device comprises at least one device selected from the group of devices consisting of a smart card reader, a debit card reader, and a signature capture device.

37. The method of claim 31, wherein the peripheral device comprises an embedded processor device.

38. The method of claim 31, wherein the peripheral device comprises a personal computer.

39. The method of claim 31, wherein the peripheral device comprises a workstation.

40. The method of claim 31, wherein the peripheral device comprises a personal digital assistant.

41. A method of operating a point-of-sale (POS) system, comprising:
providing a communication hub that comprises a plurality of communication ports;
providing a plurality of peripheral devices coupled to the communication hub via the respective communication ports, one of the plurality of peripheral devices comprising a POS management module that is configured to facilitate a POS transaction and a POS application module that is configured to facilitate an independent POS function; and
operating the one of the plurality of peripheral devices and at least one other one of the plurality of peripheral devices under the control of the POS management module of the one of the plurality of peripheral devices to perform the POS transaction.

42. The method of claim 41, further comprising:
providing a server that is communicatively coupled to the one of the plurality of peripheral devices and has data stored thereon that are used in POS transactions; and
communicating with the server to obtain information at the one of the plurality of peripheral devices that is used in operating the one of the plurality of peripheral devices and the at least one other one of the plurality of peripheral devices.

43. The method of claim 42, wherein the server is communicatively coupled to the one of the plurality of peripheral devices via the communication hub.

44. The method of claim 41, wherein the independent POS function comprises at least one function selected from the group of functions consisting of reading electrical information carried on a card, reading magnetic information carried on a card, and electronically capturing a signature.

45. The method of claim 41, wherein the one of the plurality of peripheral devices comprises at least one device selected from the group of devices consisting of a smart card reader, a debit card reader, and a signature capture device.
